(19) United States
(12) Patent Application Publication
(10) Pub. No.: US 2011/0161663 A1
(43) Pub. Date: Jun. 30, 2011

(54) INTELLIGENT CACHING FOR OCSP SERVICE OPTIMIZATION

(75) Inventor: Madjid Nakhjiri, San Diego, CA (US)

(73) Assignee: GENERAL INSTRUMENT CORPORATION, Horsham, PA (US)

(21) Appl. No.: 12/648,755

(22) Filed: Dec. 29, 2009

(51) Int. Cl. H04L 29/06

(52) U.S. Cl. 713/158

(57) ABSTRACT

An online certificate status checking protocol (OCSP) system is provided for use with a first device, an end device and a certificate authority. The first device can provide a certificate. The end device can provide an OCSP request based on the certificate and process an OCSP response. The certificate authority can provide a CRL update. The certificate has a validity period. The OCSP system includes an OCSP responder, and OCSP proxy and a cache. The OCSP responder can provide the OCSP response. The OCSP proxy can receive the OCSP request from the end device, can send the OCSP request to the OCSP responder, can receive the OCSP response from the OCSP responder and can send the OCSP response to the end device. The cache can store information based on the OCSP response. The OCSP proxy can further store, in the cache, information based on the OCSP response and can send a proactive OCSP request to the OCSP responder based on a predetermined policy. The OCSP responder can further send a proactive OCSP response to the OCSP proxy in response to the proactive OCSP request. The OCSP proxy can further update the information in the cache based on the proactive OCSP response. The OCSP proxy can additionally provide, using the updated information in the cache, a second OCSP response to the end device in response to a subsequent request from the end device related to information of the certificate.

### BACKGROUND

In a conventional public key infrastructure (PKI) security system, public key certificates (also known as digital certificates) are issued by a certificate authority (CA) to bind the public key of the subject with the subject identity. The certificate can then be used by other parties to verify that a public key belongs to a certain entity, individual or organization. However, later on, the CA may decide to revoke some of the certificates it has issued for a variety of reasons. Thus, any party that relies on certificates for performing any security functions should verify that the certificate it is using has not been revoked. The CA typically puts the serial numbers of revoked certificates on a certificate revocation list (CRL). However many devices have difficulty using CRLs for checking revocation status, due to issues such as lack of network connectivity, or insufficient bandwidth or processing power when dealing with large CRLs. Thus many PKI systems provide an online certificate status checking protocol (OCSP). Any party that holds a certificate from another party can use OCSP for verifying revocation status of the certificate instead of downloading a full CRL. This is typically done by sending an OCSP request to the CA or a designated responder (an OCSP responder) and then receiving an OCSP response.

An OCSP request contains enough information to uniquely identify the certificate (e.g., a serial number for the certificate to be checked, along with the hashed version of the CA's name and/or key). For high volume applications, the OCSP request is not signed and thus the identity of the requestor is not included in the request either. This provides some flexibility in the way the OCSP request can be generated. An OCSP response provides a status value for the identified certificate. Unlike OCSP requests, OCSP responses must be signed by an authority that the requester trusts. This is either the CA that has issued the certificate and is acting as OCSP responder or a separate OCSP responder designated by that CA.

The OCSP response has a time stamp and a validity period. The responder is identified by a hash of its public key and its certificate. The certificate for which status is being reported is identified as it was done in the OCSP request (serial number and hash of issuer name and/or key).

Although OCSP provides for an easier method for checking certificate status, there are a number of issues relating to its implementation and scalability. First of all, OCSP responses must be signed with the OCSP responder's private key, which is typically stored inside a hardware security module (HSM). So every time a signature is required, this key inside the HSM must be accessed, and used to perform the signing function, both of which takes CPU time, which is a valuable resource for the HSM. Therefore, the OCSP responder performance is directly affected by the HSM signing performance. Another issue is since OCSP is provided by an online server (over HTTP), the bandwidth of the link between the OCSP requester and the OCSP responder can be a bottleneck and a major contribution to OCSP service costs. Third, in many cases, the consumer of the OCSP service has to spend real time waiting for an OCSP response in order to be able to complete a certain function. The roundtrip delay of requesting and then receiving an OCSP response may thus have a negative effect on the performance of that function.

To address these various issues, there are several optimizations to OCSP that can be implemented. One is caching of the OCSP response. An OCSP response may be kept in a cache up to the end of its validity period. In this way, within the validity period, there may not be a need to send any more requests to the OCSP responder, and thus bandwidth and signing CPU time can be saved. The validity period is set depending on the applications and entity for which the certificate is used, the likelihood for certificate revocation and other security considerations.

This caching of the OCSP response can be used in conjunction with another OCSP optimization, the use of an OCSP proxy. An OCSP proxy can interact with an OCSP responder on behalf of the end device by sending OCSP requests, and then caching the responses and responding to the end device accordingly. This is facilitated by the fact that OCSP requests do not require signatures and thus can be issued by entities other than the end device. In some cases, OCSP proxy can also passively observe the OCSP transaction between the end device and the OCSP responder and then cache certain information (e.g. parts of or the whole OCSP response) according to its policies. Since the use of an OCSP proxy (along with a cache of OCSP responses) reduces the number of interactions with the OCSP responder, the bandwidth and overall time required to obtain an OCSP response is greatly reduced. An example of this approach will now be discussed in reference to FIG. 1.

FIG. 1 is a schematic illustrating a conventional system 100 implementing OCSP service using a proxy and a cache. System 100 includes a device 101, an end device 102, an OCSP proxy 104, a cache 106, a CRL 108, an OCSP responder 110 and a CA 112. In practice, a plurality of devices may potentially be interacting with a single end device, however to simplify explanation, only one device (device 101) is shown. Similarly, in practice, a plurality of end devices and CAs may potentially be interacting with a single OCSP proxy, however for simplicity in explanation, only one of each is shown.

In this example, presume device 101 initiates secure communication with end device 102. During initiation, device 101 provides end device 102 with a certificate of device 101, wherein the certificate includes its public key. The public key will be used by both device 101 and device 102 for secure communication. The certificate is used to verify the identity of device 101. Before end device 102 continues to securely communicate with device 101 (or very early on in the communication), it must determine whether the public key provided by device 101 is still valid. Presume in this case that device 101 has previously registered (or received) its public key with (from) CA 112. Further, presume that CA 112 had provided device 101 with a certificate of validation for its public key. The certificate will have some sort of identifier, such as a serial number, that ties the certificate to the public key of device 101 and CA 112. The certificate will additionally have a validation period, for which the certificate is “good.” After expiration of the validation period, the initial certificate is no longer usable, and the public key of device 101 may be issued a new certificate by CA 112, if required.

If end device 102 can verify that the certificate provided by device 101 is still valid, then end device 102 may securely communicate with device 101.

An example process 200 of secure communication of system 100 will now be described with reference to FIG. 2.

In operation, process 200 starts (S202) and device 101 provides end device 102 with a public key and a corresponding certificate (S204). As mentioned above, when device 101 initiates secure communication with end device 102, device 101 sends the public key and a corresponding certificate to end device 102. The certificate provides end device 102 with the capability to verify the identity of device 101.

Upon receiving the certificate, end device 102 sends an OCSP request to OCSP proxy 104 (S206), which includes the certificate identifier and issuer of the certificate to be verified. Typically the end device 102 is not aware of the presence of OCSP proxy 104, so end device 102 sends the OCSP request towards the address that end device 102 has for OCSP responder 110. The OCSP request is either intercepted by OCSP proxy 104, or the network will redirect the request to OCSP proxy 104. For example, for purposes of discussion, presume that device 101 is attempting to securely communicate with end device 102. Device 101 will send a public key having a public key certificate associated therewith to end device 102. The certificate may have a serial number associated therewith. Further, presume in this example, that the certificate of device 101 has been registered with CA 112 and thereby indirectly with OCSP responder 110.

OCSP proxy 104 then searches cache 106 for response for the certificate identifier (S208) to check if a response has been cached (S210). In this example, in the event that the certificate corresponding to the public key provided by device 101 had been recently requested, the OCSP response corresponding thereto would have been stored in cache 106.

If an OCSP response is found in cache 106, then first the status and validity period of the cached OCSP response is verified (S212). A valid (not expired) OCSP response will indicate whether the certificate corresponding to the public key provided by device 101 is still valid or has been revoked. Further, the validity of the OCSP response will indicate the time period that this OCSP response can be used to verify the status of the certificate corresponding to the public key provided by device 101, e.g., a number of days.

If cached OCSP response is still valid and indicates that the certificate status is valid and not revoked, OCSP proxy 104 then searches the latest CRL 108 for the certificate identifier (S214) to check if the certificate which corresponds to the certificate identifier, has been revoked (S216) since the time the OCSP response has been cached. There may be situations where the public key provided by device 101 has been compromised. In such situations, CA 112 may revoke the certificate corresponding to the public key provided by device 101 and add the certificate identifier (e.g. serial number) to CRL 108. In such an instance, the certificate corresponding to the public key provided by device 101 will be listed on the latest CRL 108 provided by CA 112, even though a very recent OCSP response on the same certificate might have indicated the certificate as valid. This is why OCSP proxy 104 must check the latest CRL 108 before trusting its cached OCSP responses.

If the certificate identifier is not found on CRL 108, and the validity period of the cached OCSP response includes the present time, the cached OCSP response is still valid and thus OCSP proxy 104 forwards the cached response to end device 102 (S218) and process 200 ends (S220). In this situation, the secure communication with device 101 may commence or continue.

However, if an OCSP response for the certificate identifier cannot be found in cache 106, if the cached OCSP response is expired, or if the certificate identifier is found in CRL 108, then OCSP proxy 104 forwards the OCSP request to OCSP responder 110 (S222) so that OCSP responder 110 can issue a new OCSP response for the certificate.

OCSP responder 110 then provides a signed OCSP response with a validity period (S224). In this situation, OCSP responder 110 has indicated that the certificate corresponding to the public key provided by device 101 is valid.

OCSP proxy 104 caches this new OCSP response in cache 106 (S226) according to its policies regarding the certificate. There may be an instance where end device 102, or some other device using OCSP proxy 104, may make an inquiry relating to the certificate corresponding to the public key provided by device 101. By caching the new OCSP response in cache 106, OCSP proxy 104 will not need to check with OCSP responder 110, as discussed above with reference to step S210 for future queries.

Finally OCSP proxy 104 forwards the new response to end device 102 (S218) and process 200 ends (S220). If the OCSP response indicates that the certificate is valid, at this point end device 102 is that the certificate corresponding to the public key provided by device 101 is good, and secure communication with device 101 may commence. If the OCSP response indicates that the certificate was revoked, end device 102 will follow the prescribed policies regarding revoked certificates and typically this at least includes: not starting, if it has already started, ending communications with device 101.

Concurrent with performance of process 200, CRL 108 is updated on a regular basis by CA 112, such that CRL 108 maintains a current list of the revoked certificates. OCSP responder 110 is also regularly updated with CRL data, such that it can provide the appropriate response when prompted by OCSP proxy 104. To perform the optimizations described here, OCSP proxy 104 is also regularly updated with the CRL data from CA 112.

As illustrated in FIGS. 1 and 2, OCSP proxy 104 manages the OCSP requests from end device 102 such that interaction with OCSP responder 110 is reduced. By storing OCSP responses in cache 106, OCSP proxy 104 may provide end device 102 with OCSP responses without contacting OCSP responder 110. Only when responses are expired, revoked, or not found in cache 106 is it necessary for OCSP proxy 104 to contact OCSP responder 110 such that a new response can be obtained and forwarded to end device 102. In this manner, the bandwidth consumption between end device 102 and OCSP responder 110 is reduced. Further, the number of times OCSP responder 110 must sign an OCSP response (requiring access of private key stored in HSM, taking up CPU time) is reduced, thus improving the overall speed of the OCSP request/response process.

While this use of response caching and proxies is effective in improving the performance of OCSP systems, there is still a need for further improvement.

What is needed is a system and method which implements “intelligent” caching of OCSP responses such that the performance of OCSP service can be further optimized.

### BRIEF SUMMARY

The present invention provides a system and method for implementing “intelligent” caching of OCSP responses such that the performance of OCSP service can be further optimized.

In accordance with an aspect of the present invention, an online certificate status checking protocol (OCSP) system is provided for use with a first device, an end device and a certificate authority. The first device can provide a certificate. The end device can provide an OCSP request based on the certificate and process an OCSP response. The certificate authority can provide a CRL update. The certificate has a validity period. The OCSP system includes an OCSP responder, and OCSP proxy and a cache. The OCSP responder can provide the OCSP response. The OCSP proxy can receive the OCSP request from the end device, can send the OCSP request to the OCSP responder, can receive the OCSP response from the OCSP responder and can send the OCSP response to the end device. The cache can store information based on the OCSP response. The OCSP proxy can further store, in the cache, information based on the OCSP response and can send a proactive OCSP request to the OCSP responder based on a predetermined policy. The OCSP responder can further send a proactive OCSP response to the OCSP proxy in response to the proactive OCSP request. The OCSP proxy can further update the information in the cache based on the proactive OCSP response. The OCSP proxy can additionally provide, using the updated information in the cache, a second OCSP response to the end device in response to a subsequent request from the end device related to information of the certificate.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 is a schematic illustrating a conventional system implementing OCSP service using a proxy and a cache;

FIG. 2 illustrates an example method for the operation of the conventional system of FIG. 1;

FIG. 3 illustrates an example method for the operation of system FIG. 1, in accordance with an aspect of the present invention; and

FIG. 4 illustrates an example method for the maintenance of a cache and a CRL in accordance with an aspect of the present invention.

### DETAILED DESCRIPTION

In accordance with an aspect of the present invention, a system and process are provided that implement intelligent caching (e.g. frequency-based predictive caching) within an OCSP system. By maintaining a cache of OCSP responses based on predetermined policies, the performance/cost of OCSP service can be further optimized. Non-limiting examples of predetermined policies in accordance with aspects of the present invention include a predetermined policy based on the types of devices and a predetermined policy based on a frequency of query for status checking on the device certificate.

There are many instances where hundreds of devices (for example, hundreds of devices like end device 102) need to verify the validity of the certificate of devices such as device 101, for example, on every given minute or less. These thousands of devices would rely on the OCSP response regarding the certificate for device 101. This would mean that OCSP responder 110 will need to sign and return hundreds of OCSP responses on the same certificate. In a network having a large number of devices such as device 101, will introduce a large load for OCSP responders responding to end devices such as device 102 querying the validity of certificates for devices such as device 101. Caching the server certificate OCSP responses on OCSP proxy 104 could reduce the need for OCSP requests from OCSP proxy 104 by orders of magnitude. Furthermore, the daily routine maintenance of cache 106 can be done in off rush yours, e.g., nighttime, when the OCSP traffic is low.

In accordance with an aspect of the present invention, OCSP proxy 104 caches the OCSP responses based on policies and then monitors OCSP response entries in cache 106 on a regular basis. OCSP proxy 104 then compares the validity of the OCSP response entries based on their validity period. For example, some OCSP response entries may have been in cache 106 for 31 days, whereas their validity period is only 30 days. Such OCSP response entries would therefore be invalid. OCSP proxy 104 may then decide which entries should be dropped from cache 106 or refreshed within cache 106 based on a predetermined policy.

In one example policy, OCSP proxy 104 decides which OCSP response entries in cache 106 should be dropped or refreshed based on the number of OCSP requests for a certificate. For example, an OCSP response entry in cache 106 corresponding to a certificate that has not been queried in weeks since its initial query is unlikely to be queried within the next day. On the other hand, an OCSP response entry in cache 106 corresponding to a certificate that has been queried several times in the last day will very likely be queried again in the next day. Therefore, automatically refreshing the OCSP response entry in cache 106 corresponding to a certificate that has been queried a several times in the last day will preempt the need to refresh the OCSP response the first time it is queried after the validity period of that OCSP response expires.

In another example policy, OCSP proxy 104 decides which OCSP response entries in cache 106 should be dropped or refreshed based on whether the certificate is now on CRL 108. For example, an OCSP response entry in cache 106, indicating a valid certificate, corresponding to a certificate that was previously valid, but has been revoked by CA 112 can no longer be used. The certificate will now be listed on CRL 108 and thus OCSP response for that certificate should now indicate a revoked status. If such policy is in place, OCSP proxy 104 can request OCSP responder 110 to sign a new OCSP response for this revoked certificate and instead cache the new response that indicates the certificate is now revoked. Alternatively, OCSP proxy 104 may simply just remove all such OCSP response entries from cache 106 (for certificates that are on CRL 108), and thereby the remaining number of entries in cache 106 will decrease thereby decreasing search time.

In another example policy, OCSP proxy 104 decides which OCSP response entries in cache 106 should be dropped from or refreshed based whether the validity of the OCSP response is too close to expiration. For example, suppose there is an OCSP response entry in cache 106, whose validity will expire in one minute or one hour or one day. In such a case, a policy might be in place to determine whether it is more efficient to let that OCSP response expire and delete it from cache 106 or have OCSP proxy 104 proactively create an OCSP request to replace the expiring cache with a fresh one. The policy for determination on use of proactive OCSP requests can be based a variety of factors, such as number of queries for that certificate validity, cost of certificate, size of cache, etc.

In accordance with another aspect of the present invention, OCSP proxy 104 may set a priority for proactive OCSP requests, based on policies. In one example policy, OCSP proxy 104 may set a priority based on which it would send the proactive OCSP requests. The priority may be based on the costs of the certificates (type of device) corresponding to the OCSP requests. In another example policy, OCSP proxy 104 may set a priority for proactive OCSP requests, based on the popularity of certificates corresponding to the OCSP requests, e.g., how often a certificate is queried. Another example policy for setting the priority may be the time left from validity period for the cached OCSP response.

In accordance with another aspect of the present invention, OCSP proxy 104 may, based on its policies, suggest specific validity periods for the OCSP response to OCSP responder 110. The suggestion may take the form of an OCSP request extension or as a proprietary message. OCSP responder 110 may then, in response, set the validity period for the provided OCSP response based on the value hinted/requested by OCSP proxy 104 or ignore the hinted value.

In accordance with another aspect of the present invention, OCSP proxy 104 may interact with end device 102 in a non-OCSP manner. For example, OCSP proxy 104 may receive a certificate, e.g., from end device 102 for device 101, as part of a proprietary or standard communication protocol. OCSP proxy 104 may then generate an OCSP request that includes an extension indicating to OCSP responder 110 that end device 102 does not understand OCSP. In this manner, OCSP responder 110 may provide minimum information to end device 102, such as a certificate serial number, a status, a date and a signature by the OCSP responder.

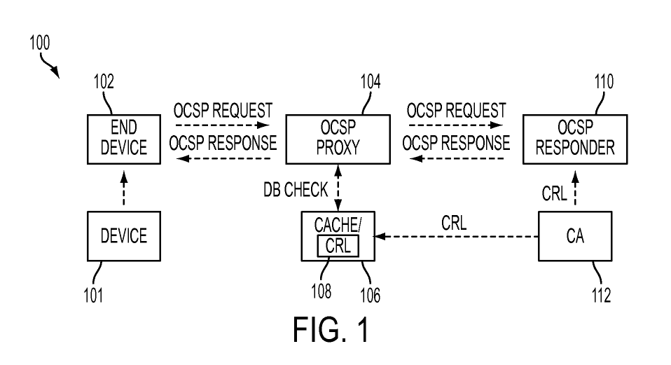

An example embodiment in accordance with an aspect of the present invention will now be described with reference to FIGS. 1, 3 and 4.

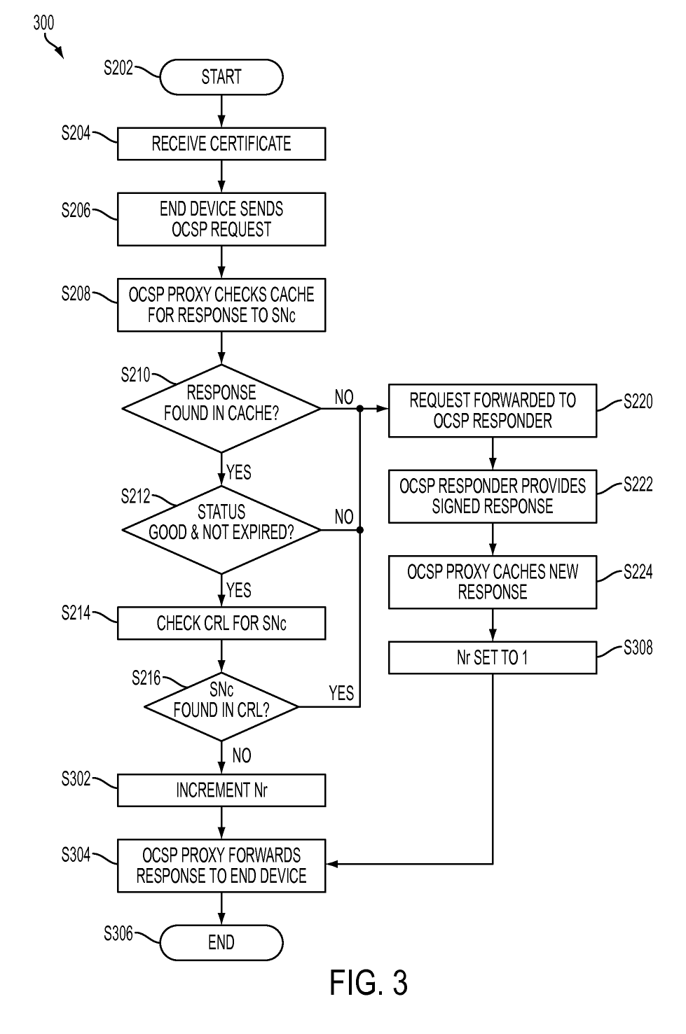

In accordance with an aspect of the present invention, system 100 of FIG. 1 is used to implement an OCSP service, but with a different method of operation, such that the frequency of requests for each OCSP response is monitored and then predictive caching of the OCSP response is done so accordingly. First, an example process 300 for the general operation of system 100, in accordance with an aspect of the present invention, will be described with reference to FIG. 3.

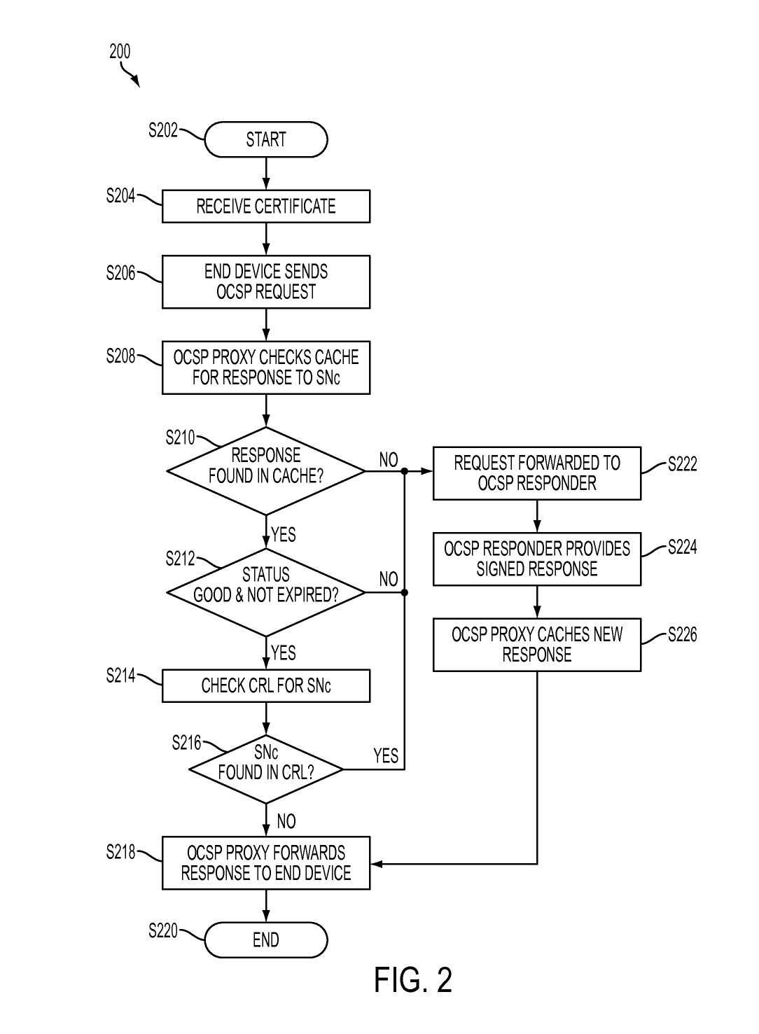

In operation, process 300 is similar to process 200 discussed above with reference to FIG. 2 up to step S216, wherein if status the and validity period is good and not expired, OCSP proxy 104 then searches CRL 108 for the certificate identifier to check if the certificate has been revoked. Again, for purposes of discussion, presume that device 101 is attempting to securely communicate with end device 102. In process 300, after step S216, if the certificate is not found on CRL 108, then the OCSP response is deemed to still be valid. At this point, OCSP proxy 104 increments the number of requests for the OCSP response corresponding to the public key provided by device 101 (S302).

OCSP proxy 104 then forwards the cached response to end device 102 (S304) and process 300 ends (S306). At this point end device 102 is assured that the certificate corresponding to the public key provided by device 101 is good and secure communication with device 101 may commence.

Similar to process 200, in process 300, if in step S210 a response for the certificate identifier cannot be found in cache, or if in step S212 the cached response is expired or if in step S216 the certificate identifier is found in CRL 108, then OCSP proxy 104 forwards the OCSP request to OCSP responder 110 (S222). Additionally similar to process 200, in process 300, at this point, OCSP responder 110 then provides a signed OCSP response with a validity period (S224) and OCSP proxy 104 caches this new OCSP response in cache 106 (S226).

In contrast with method 200, in method 300, number of requests of the new OCSP response is set to 1, since this is the first time the new response is being requested (S308).

Finally, OCSP proxy 104 forwards the new OCSP response to end device 102 (S304) and process 200 ends (S306). At this point end device 102 is assured that the OCSP response on the certificate corresponding to the public key provided by device 101 is a valid one. If the OCSP response indicates a valid certificate, then end device 102 is assured the certificate is good, and secure communication with device 101 may commence. If on the other hand, the OCSP response indicates the certificate is revoked, then end device 102 will reject any attempt from device 101 to establish communications or associations or terminate any communications or associations if such is already in place.

Concurrent with performance of process 300, CRL 108 is updated on a regular basis by CA 112, such that CRL 108 maintains a current list of the revoked certificates. OCSP responder 110 is also regularly updated with CRL data, so it can provide the appropriate response when so prompted by OCSP proxy 104. This is similar to the conventional implementation of OCSP service. However, unlike the conventional implementation, in accordance with an aspect of the present invention, OCSP proxy 104 also updates and maintains cache 106 in a certain manner to allow for predictive caching based on the frequency of response requests. This process will be described in further detail below.

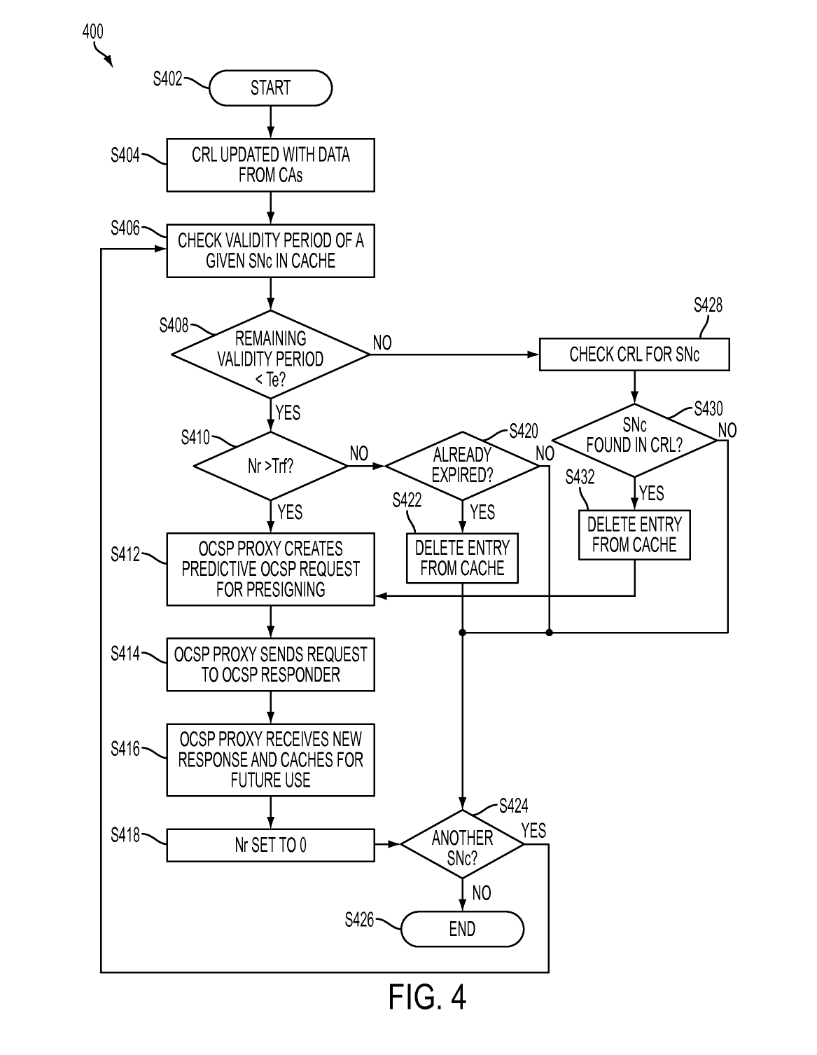

An example process 400 for the maintenance of cache 106 and CRL 108 in accordance with an aspect of the present invention will now be described with reference to FIG. 4.

Process 400 starts (S402) and CRL 108 is updated with CRL data from CA 112 (S404). The CRL data includes an updated list of certificates corresponding to public keys, respectively, that have been revoked. The certificates may be listed as certificate identifiers, non-limiting examples of which include serial numbers.

If certificate identifier in OCSP response cache 106 indicating a good certificate is not on CRL 108, then it the OCSP response is still considered to be valid and certificate status still valid (not revoked). For each certificate identifier with OCSP response indicating a good status in cache 106, OCSP proxy 104 examines the OCSP response validity period (S406).

It is then determined whether the remaining validity period is below a predetermined expiration threshold (S408). This predetermined expiration threshold may be static or may be changed based on the needs of system 100. For example, if it is determined that an original predetermined expiration threshold of 30 days is too long, the system may be configured to reduce the predetermined expiration threshold.

If it is determined that the remaining validity period of a certificate identifier is below the predetermined expiration threshold, it is then determined whether the number of requests for the certificate identifier is greater than a request frequency threshold (S410). For example, if a particular certificate identifier has been requested many times within a predetermined time period, there is an increased likelihood the particular certificate identifier will be requested again in the near future. Alternatively, if a particular certificate identifier has not been requested at all within a predetermined time period, there is a deceased likelihood the particular certificate identifier will be requested again in the near future. In such cases, there may be other policies that would dictate OCSP proxy 104 to create predictive OCSP requests for pre-signing. Non-limiting examples of such policies include predictive OCSP requests for pre-signing when the cost of the certificate is high, or predictive OCSP requests for pre-signing based on the type of device such that maintaining cache 106 is considered to have economic value.

If it is determined that the number of requests for a certificate identifier is greater than the request frequency threshold, this indicates that the certificate is one that is frequently queried, and thus keeping a response cached would be economical. Since the validity period of the response is about to expire, however, a new response is needed to replace it in cache 106. Thus, OCSP proxy 104 creates a predictive OCSP request for pre-signing (S412), and sends this request to OCSP responder 110 (S414).

OCSP proxy 104 receives the new signed response from OCSP responder 110 and then caches the new response for future use (S416). The number of requests Nr for this new response is then set to 0 (S418). Then, OCSP proxy 104 checks if there are more certificate identifiers with a good status in cache 106 to check (S424). If not, process 400 ends (S426) and update of cache 106 is completed for that time period. If there are more responses to check, process 400 returns to step S406 and the process repeats with the next serial number in cache 106.

Returning back to step S408, if the remaining validity period of the response is not about to expire, then the next step is to search CRL 108 for the serial number (S428). OCSP proxy 104 checks if the certificate identifier is found in CRL 108 (S430) and if not, the current cached response for that certificate identifier is still useable and therefore the process moves on to check the response for the next certificate identifier in cache 106 (S424). However, if the certificate identifier is found in CRL 108, then that means that the certificate is now revoked and a new response (indicating the certificates “revoked” status) is now needed. Thus OCSP proxy 104 deletes the current cached response from cache 106 (S432) and then goes on to create a pre-signing request to be sent to OCSP responder 110 (S412) such that an updated response (noting a “revoked” certificate status) can be obtained from OCSP responder 110.

Returning back to step S410, for the case when the number of requests is actually less than the predetermined threshold, OCSP proxy 104 first checks if the response is already expired (S420). If so, this indicates that the certificate was not being checked frequently enough for OCSP proxy 104 to refresh its cached response, and thus the response is deleted from cache 106 (S422), and the process moves on to check the next certificate identifier (S424). However, if the response was not already expired, then it is simply left alone and the process moves on to check the next certificate identifier (S424).

The above process details how OCSP proxy 104 regularly maintains cache 106 and CRL 108 such that the performance of OCSP service is further optimized. Note that in order to be effective in improving performance, OCSP proxy 104 needs to perform process 400 on a regular, relatively frequent basis with an interval that is smaller than the OCSP response validity interval. For example, process 400 may be performed on a daily basis (such that cache 106 and CRL 108 are each updated daily), while the OCSP response validity interval may be 30 days.

Regarding the pre-signing requests being sent to OCSP responder 110 (such as in steps 5412 and step S414 in process 400), in accordance with an aspect of the present invention, OCSP proxy 104 may prioritize the pre-signing requests, so that requests with higher priority are sent to OCSP responder 110 first. High priority may be given based on a variety of factors. More frequently queried certificates (those responses with higher Nr) can be given higher priority. Responses with validity periods closer to expiration may be given higher priority. There may also be other policies that determine the priority, such as the cost of the certificate or type of certificate. In accordance with an aspect of the present invention, the priority may be implemented by the amount of time ahead of the expiry data the pre-signing request is issued. For example, very high priority certificates can be pre-signed 7 days prior to expiry, while medium-priority ones 5 days prior, and others 1 day prior.

Any of end device 102, OCSP proxy 104, CRL 108, OCSP responder 110 and CA 112 may be embodied in hardware, software, or a combination of both. When embodied in software, any of end device 102, OCSP proxy 104, CRL 108, OCSP responder 110 and CA 112 may be embodied in the form of program code (i.e., instructions). This program code may be stored on a computer-readable medium, such as a magnetic, electrical, or optical storage medium, non-limiting examples of which include a floppy diskette, a CD-ROM, a CD-RW, a DVD-ROM, a DVD-RAM, a magnetic tape, a flash memory, a hard disk drive, or any other machine-readable storage medium, wherein, when the program code is loaded into and executed by a machine, such as a computer or server, the machine becomes an apparatus for practicing aspects of the present invention, or portions thereof. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

Any of end device 102, OCSP proxy 104, CRL 108, OCSP responder 110 and CA 112 may also be embodied in the form of program code that is transmitted over some transmission medium, such as over electrical wiring or cabling, through fiber optics, over a network, including a local area network, a wide area network, the Internet or an intranet, or via any other form of transmission, wherein, when the program code is received and loaded into and executed by a machine, such as a computer, the machine becomes an apparatus for practicing aspects of the present invention, or portions thereof.

When implemented on a general-purpose processor, the program code may combine with the processor to provide a unique apparatus that operates analogously to specific logic circuits.

Although not required, any of end device 102, OCSP proxy 104, CRL 108, OCSP responder 110 and CA 112 may be implemented via an operating system, for use by a developer of services for a device or object, and/or included within application or server software that operates in accordance with methods and apparatuses in accordance with aspects of the present invention, or portions thereof. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, any of end device 102, OCSP proxy 104, CRL 108, OCSP responder 110 and CA 112 may be practiced with other computer system configurations and protocols. Other well known non-limiting examples of computing systems, environments, and/or configurations that may be suitable for use with methods and apparatuses in accordance with aspects of the present invention, or portions thereof, include personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like.

Any of end device 102, OCSP proxy 104, CRL 108, OCSP responder 110 and CA 112 may include a variety of computer readable media. Computer readable media can be any available media that can be accessed and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Non-limiting examples of computer storage media include RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. Non-limiting examples of communication media include wired media such as a wired network or direct-wired connection, and wireless media such as acoustic, RF, infrared and other wireless media. Combinations of any of the above should also be included within the scope of computer readable media.

As mentioned previously in reference to FIG. 3, when signing a new OCSP response, OCSP responder 110 sets the response validity period to a given time (e.g., 30 days). However, in accordance with an aspect of the present invention, OCSP proxy 104 may actually request OCSP responder 110 to set the validity period of the signed OCSP response to a specific amount, based on a policy such as frequency of requests, cost of certificate, or security environment. For example, if a certificate is less frequently requested or is of low cost, the OCSP response validity period can be requested to be long. This can be requested using a new validity period extension appended to the OCSP request, or a proprietary messaging method (non-OCSP messaging) between OCSP proxy 104 and OCSP responder 110. OCSP responder 110 may, based on its own policy, accept or override the requested value.

In system 100 of FIG. 1, it was assumed that end device 102 has OCSP capability (e.g., capability to send OCSP requests and receive OCSP responses). However, in accordance with an aspect of a present invention, end devices without OCSP capability may also send requests to verify certificate status. For end devices that do not have OCSP capability, OCSP proxy 104 can accept a proprietary certificate status checking request (non-OCSP) from the client interested in certificate validation. OCSP proxy 104 then creates an OCSP request based on either OCSP standard (RFC 2560 or RFC 5019) but includes a non-standard OCSP_not_supported extension. OCSP responder 110 can create an OCSP response for OCSP proxy 104 to cache for other OCSP-capable end devices. Further, OCSP responder 110 can include an extension non_OCSP_response with enough information for end device 102 to assert the validity of the status checking results. This information could include: hash of OCSP responder 110's key, certificate serial number, date of status checking, and a signature calculated using OCSP responder 110's public key.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. An online certificate status checking protocol system for use with a first device, an end device and a certificate authority, the first device being operable to provide a certificate, the end device being operable to provide an online certificate status checking protocol request based on the certificate and process an online certificate status checking protocol response, the certificate authority being operable to provide a certificate revocation list update, the certificate having a validity period, said online certificate status checking protocol system comprising:
an online certificate status checking protocol responder operable to provide the online certificate status checking protocol response,
an online certificate status checking protocol proxy operable to receive the online certificate status checking protocol request from the end device, to send the online certificate status checking protocol request to said online certificate status checking protocol responder, to receive the online certificate status checking protocol response from said online certificate status checking protocol responder and to send the online certificate status checking protocol response to the end device; and
a cache operable to store information based on the online certificate status checking protocol response,
wherein said online certificate status checking protocol proxy is further operable to store, in said cache, information based on the online certificate status checking protocol response,
wherein said online certificate status checking protocol proxy is further operable to send a proactive online certificate status checking protocol request to said online certificate status checking protocol responder based on a predetermined policy,
wherein said online certificate status checking protocol responder is further operable to send a proactive online certificate status checking protocol response to said online certificate status checking protocol proxy in response to the proactive online certificate status checking protocol request,
wherein said online certificate status checking protocol proxy is further operable to update the information in said cache based on the proactive online certificate status checking protocol response, and
wherein said online certificate status checking protocol proxy is further operable to provide, using the updated information in said cache, a second online certificate status checking protocol response to the end device in response to a subsequent request from the end device related to information of the certificate.

2. The online certificate status checking protocol system of claim 1, wherein said online certificate status checking protocol proxy is further operable to provide a second request to said online certificate status checking protocol responder for a second online certificate status checking protocol response after finding a certificate on the certificate revocation list and based on a second predetermined policy.

3. The online certificate status checking protocol system of claim 2, wherein said online certificate status checking protocol proxy is operable to provide the second request based on at least one of a number of instances said online certificate status checking protocol proxy has received an online certificate status checking protocol request corresponding to the first device and a cost of a certificate corresponding to the first device.

4. The online certificate status checking protocol system of claim 1, wherein said online certificate status checking protocol proxy is further operable to provide a second request to said online certificate status checking protocol responder to set the validity period of the online certificate status checking protocol response to a specific amount based on a second predetermined policy.

5. The online certificate status checking protocol system of claim 4, wherein said online certificate status checking protocol proxy is operable to provide the second request based on at least one of a number of instances said online certificate status checking protocol proxy has received an online certificate status checking protocol request corresponding to the first device and a cost of a certificate corresponding to the first device.

6. The online certificate status checking protocol system of claim 1, wherein said online certificate status checking protocol proxy is further operable to provide the online certificate status checking protocol request to said online certificate status checking protocol responder with an extension indicating that the end device does not understand online certificate status checking protocol.

7. The online certificate status checking protocol system of claim 6, wherein said online certificate status checking protocol responder is further operable to provide the online certificate status checking protocol response to include at least a certificate serial number in response to receiving the online certificate status checking protocol request with the extension.

8. A method of using a system including a first device, an end device and a certificate authority, the first device being operable to provide a certificate, the end device being operable to provide an online certificate status checking protocol request based on the certificate and process an online certificate status checking protocol response, the certificate authority being operable to provide a certificate revocation list update, the certificate having a validity period, said method comprising:
receiving, by way of an online certificate status checking protocol proxy, the online certificate status checking protocol request from the end device;
providing, by way of the online certificate status checking protocol proxy, the online certificate status checking protocol request;
receiving, by way of an online certificate status checking protocol responder, the online certificate status checking protocol request;
providing, by way of the online certificate status checking protocol responder, an online certificate status checking protocol response;
receiving, by way of the online certificate status checking protocol proxy, the online certificate status checking protocol response from the online certificate status protocol responder;
sending, by way of the online certificate status checking protocol proxy, the online certificate status checking protocol response to the end device;
storing, within a cache, information based on the online certificate status checking protocol response;
storing, within the cache, information based on the online certificate status checking protocol request;
sending, by way of the online certificate status checking protocol proxy, a proactive online certificate status checking protocol request to the online certificate status checking protocol responder based on a predetermined policy;
sending, by way of the online certificate status checking protocol responder, a proactive online certificate status checking protocol response to the online certificate status checking protocol proxy in response to the proactive online certificate status checking protocol request;
updating the information in the cache based on the proactive online certificate status checking protocol response; and
providing, by way of the online certificate status checking protocol proxy using the updated information in the cache, a second online certificate status checking protocol response to the end device in response to a subsequent request from the end device related to information of the certificate.

9. The method of claim 8, further comprising providing, by way of the online certificate status checking protocol proxy, a second request to the online certificate status checking protocol responder for a second online certificate status checking protocol response after finding a certificate on the certificate revocation list and based on a second predetermined policy.

10. The method of claim 9, wherein said providing, by way of the online certificate status checking protocol proxy, a second request is based on at least one of a number of instances of receiving an online certificate status checking protocol request corresponding to the first device and a cost of a certificate corresponding to the first device.

11. The method of claim 8, further comprising providing, by way of the online certificate status checking protocol proxy, a second request to the online certificate status checking protocol responder to set the validity period of the online certificate status checking protocol response to a specific amount based on a second predetermined policy.

12. The method of claim 11, wherein said providing, by way of the online certificate status checking protocol proxy, a second request is based on at least one of a number of instances of receiving an online certificate status checking protocol request corresponding to the first device and a cost of a certificate corresponding to the first device.

13. The method of claim 8, further comprising providing, by way of the online certificate status checking protocol proxy, the online certificate status checking protocol request to the online certificate status checking protocol responder with an extension indicating that the end device does not understand online certificate status checking protocol.

14. The method of claim 13, further comprising providing, by way of the online certificate status checking protocol responder, the online certificate status checking protocol response to include at least a certificate serial number in response to receiving the online certificate status checking protocol request with the extension.

15. Computer-readable media for use in an online certificate status checking protocol computer in a system including a first device, an end device, an online certificate status checking protocol responder and a certificate authority, the first device being operable to provide a certificate, the end device being operable to provide an online certificate status checking protocol request based on the certificate and process an online certificate status checking protocol response, the online certificate status checking protocol responder being operable to provide the online certificate status checking protocol response, the certificate authority being operable to provide a certificate revocation list update, the certificate having a validity period, said computer-readable media having computer-readable instructions stored thereon, the computer-readable instructions being capable of instructing the online certificate status checking protocol computer to perform the method comprising:
receiving, by way of an online certificate status checking protocol proxy, the online certificate status checking protocol request from the end device;
providing, by way of the online certificate status checking protocol proxy, the online certificate status checking protocol request;
receiving, by way of an online certificate status checking protocol responder, the online certificate status checking protocol request;
providing, by way of the online certificate status checking protocol responder, an online certificate status checking protocol response;
receiving, by way of the online certificate status checking protocol proxy, the online certificate status checking protocol response from the online certificate status protocol responder;
sending, by way of the online certificate status checking protocol proxy, the online certificate status checking protocol response to the end device;
storing, within a cache, information based on the online certificate status checking protocol response;
storing, within the cache, information based on the online certificate status checking protocol request;
sending, by way of the online certificate status checking protocol proxy, a proactive online certificate status checking protocol request to the online certificate status checking protocol responder based on a predetermined policy;
sending, by way of the online certificate status checking protocol responder, a proactive online certificate status checking protocol response to the online certificate status checking protocol proxy in response to the proactive online certificate status checking protocol request;
updating the information in the cache based on the proactive online certificate status checking protocol response; and
providing, by way of the online certificate status checking protocol proxy using the updated information in the cache, a second online certificate status checking protocol response to the end device in response to a subsequent request from the end device related to information of the certificate.

16. The computer-readable media of claim 15, wherein the computer-readable instructions being capable of instructing the online certificate status checking protocol computer to perform the method further comprising providing, by way of the online certificate status checking protocol proxy, a second request to the online certificate status checking protocol responder for a second online certificate status checking protocol response after finding a certificate on the certificate revocation list and based on a second predetermined policy.

17. The computer-readable media of claim 6, wherein the computer-readable instructions being capable of instructing the online certificate status checking protocol computer to provide, by way of the online certificate status checking protocol proxy, a second request is based on at least one of a number of instances of receiving an online certificate status checking protocol request corresponding to the first device and a cost of a certificate corresponding to the first device.

18. The computer-readable media of claim 15, wherein the computer-readable instructions being capable of instructing the online certificate status checking protocol computer to perform the method further comprising providing, by way of the online certificate status checking protocol proxy, a second request to the online certificate status checking protocol responder to set the validity period of the online certificate status checking protocol response to a specific amount based on a second predetermined policy.

19. The computer-readable media of claim 18, wherein the computer-readable instructions being capable of instructing the online certificate status checking protocol computer to provide, by way of the online certificate status checking protocol proxy, a second request is based on at least one of a number of instances of receiving an online certificate status checking protocol request corresponding to the first device and a cost of a certificate corresponding to the first device.

20. The computer-readable media of claim 15, wherein the computer-readable instructions being capable of instructing the online certificate status checking protocol computer to perform the method further comprising providing, by way of the online certificate status checking protocol proxy, the online certificate status checking protocol request to the online certificate status checking protocol responder with an extension indicating that the end device does not understand online certificate status checking protocol.
